(19) United States
(12) Patent Application Publication
(10) Pub. No.: US 2015/0144412 A1
(43) Pub. Date: May 28, 2015

(54) SNOW VEHICLE SUSPENSION SYSTEM

(71) Applicant: Allen Mangum, Ponderay, ID (US)

(72) Inventor: Allen Mangum, Ponderay, ID (US)

(21) Appl. No.: 14/555,966

(22) Filed: Nov. 28, 2014

Related U.S. Application Data
(60) Provisional application No. 61/909,916, filed on Nov. 27, 2013.

(51) Int. Cl. B62M 27/02

(52) U.S. Cl. CPC B62M 27/02; B62M 2027/021; B62M 2027/026
USPC 180/185

(57) ABSTRACT

An apparatus and device are provided for a self-propelled roping training system. The apparatus includes an endless track comprising a plurality of corner sections, each of the plurality of corner sections comprising an arc length, a carriage assembly comprising a front slider assembly coupled with the track and a rear slider assembly coupled with the track, and a self-propelled vehicle coupled with the carriage assembly configured to follow a path defined by the endless track.

### CROSS-REFERENCES TO RELATED APPLICATIONS

This application claims the benefit of and claims priority to U.S. Provisional Patent Application No. 61/909,916 entitled “SNOW VEHICLE SUSPENSION SYSTEM” and filed on Nov. 27, 2013 for Allen Mangum, which is incorporated herein by reference.

### TECHNICAL FIELD

The present disclosure relates in general to tracked vehicles and in particular to a tracked vehicle suspension with leaning capability.

### BACKGROUND

Tracked vehicles have long been used for travel over snow. Generally, snowmobiles are used for various applications including trail riding, mountain riding, and touring. Additionally, many types of wheeled vehicles have been converted for travel over snow and ice. For example, Ford Model-T automobiles and even older types were long ago converted for use in winter snows by bolting drive tracks and skis where the wheels were originally. More recently, a number of people and companies have offered components, kits, and whole assemblies to convert ordinary motorcycles, ATVs, and other wheeled vehicles for winter use. Some of these are easily reversible, and the skis and drive tracks can be removed and the original wheels reinstalled for summer use.

Regardless of whether the vehicle is a snowmobile or a wheeled vehicle converted to a tracked vehicle, tracked vehicles typically include a drive shaft mounted to a suspension system that supports the endless track. The drive shaft typically includes drive sprockets that engage the endless track. Irregularities in the snow and ice covered terrain cause the suspension system to move. Shock absorbers are typically used to absorb the movement of the suspension system. Common suspension systems are configured to collapse towards the tracked vehicle when absorbing the movement. However, in some situations, the irregularities in the terrain cause movement in the suspension away from the tracked vehicle that is not accommodated by the suspension system.

### SUMMARY

An apparatus and system for a tracked vehicle suspension is disclosed. The apparatus, in one embodiment, includes a tunnel having upper rollers for supporting an upper portion of the endless track, and a front strut coupling track slides to the tunnel. Each of the track slides includes a plurality of lower rollers for supporting a lower portion of the endless track. In one embodiment, the front strut includes a lower tube for engaging a cross shaft disposed between the track slides. The cross shaft may be formed with a protruding fulcrum about which the lower tube pivots such that the front strut pivots laterally with respect to the track slides.

In one embodiment, the front strut includes an upper tube coupled at each end with the tunnel and side tubes coupling the upper tube with the lower tube. The apparatus may also include a front shock absorber coupled at a first end with the upper tube and coupled at a second end with a cross bar disposed between the track slides.

In another embodiment, the apparatus includes a rear strut coupling the track slides to the tunnel, where the rear strut engages a rear cross shaft disposed between the track slides such that the rear strut is substantially laterally fixed in relation to the track slide. The apparatus may also include a rear shock absorber coupled at a first end with the rear strut and coupled at a second end with a cross bar disposed between the track slides. In one embodiment, the track slides, the front shock, the rear shock, the front strut, the rear strut, the plurality of upper rollers, and the plurality of lower rollers are disposed within the endless track.

In one embodiment, the apparatus also includes a bushing disposed between the fulcrum and the lower tube, and a positionable adjuster disposed on the cross shaft, where the positionable adjuster comprises an exterior surface that engages an end of the lower tube to limit the pivoting of the front strut about the fulcrum. The exterior surface may vary in diameter to adjust a range of pivoting motion of the front strut.

The system, in one embodiment, includes the above described apparatus together with a motorcycle frame. The tunnel, for example, may be coupled with a subframe, and a strut disposed between the subframe and a motorcycle frame. In one embodiment, the strut rigidly couples the subframe with the motorcycle frame, such that the subframe is substantially fixed in relation to the motorcycle frame.

In another embodiment, the motorcycle frame is coupled with a front suspension system. The front suspension system may include a pair of shock absorbers coupled with the motorcycle frame at upper ends of the pair of shock absorbers, and a steering ski disposed between the pair of shock absorbers at lower ends of the pair of shock absorbers.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a side view diagram illustrating one embodiment of a track conversion system for a motorcycle in accordance with embodiments of the invention;

FIG. 2 is a side view diagram illustrating one embodiment of the rear track assembly for converting a motorcycle to a snow vehicle in accordance with embodiments of the invention;

FIGS. 3a and 3b jointly depict embodiments of directions of pivoting with reference to the front and rear struts in accordance with embodiments of the invention;

FIG. 4 is a perspective view diagram illustrating one embodiment of the front strut in accordance with embodiments of the invention;

FIG. 5 is an exploded view diagram illustrating one embodiment of the front strut in accordance with embodiments of the invention; and

FIG. 6 is a cross sectional diagram illustrating one embodiment of the front strut in accordance with embodiments of the invention.

### DETAILED DESCRIPTION

The subject matter of the present application has been developed in response to the present state of the art, and in particular, in response to the problems and needs in the art that have not yet been fully solved by currently available snow vehicle conversion kits for motorcycles. Accordingly, the subject matter of the present application has been developed to provide a snow suspension system that overcomes at least some shortcomings of the prior art.

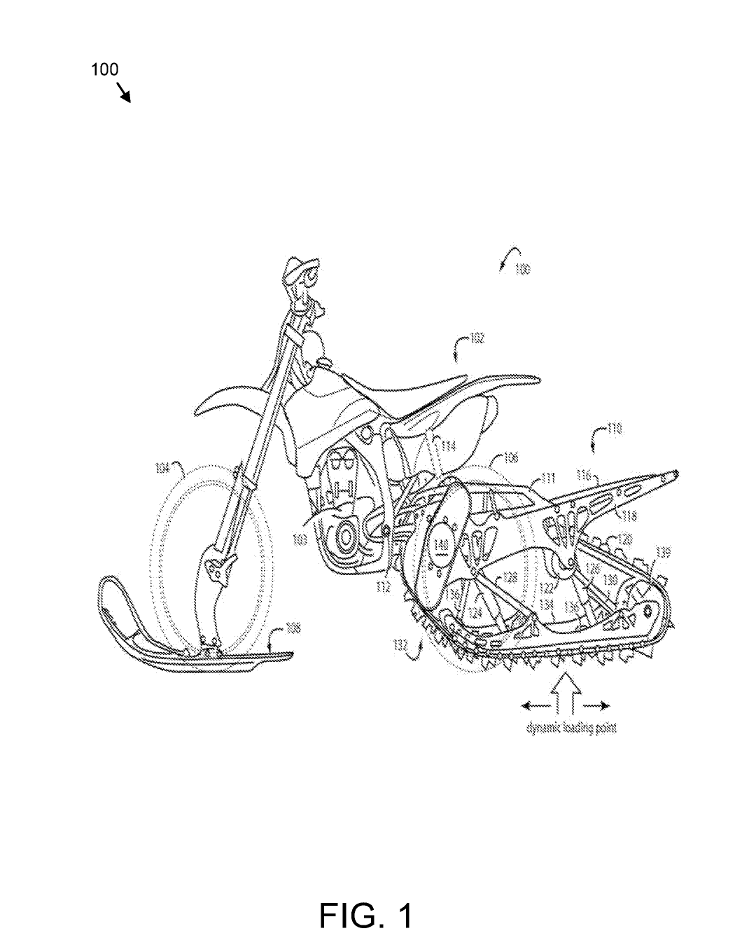

FIG. 1 is a side view diagram illustrating one embodiment of a track conversion system for a motorcycle in accordance with embodiments of the invention. The track conversion system 100 comprises, in one embodiment, a motorcycle 102 with an engine 103 which has had its front wheel 104 and rear wheel 106 and rear swing-arm suspension removed. In one embodiment, a single front steering ski 108 and a rear track drive assembly 110 replace the front wheel 104 and the rear wheel 106, respectively. Examples of a front steering ski 108 capable of use with embodiments of the invention include a dual- or tri-keel ski manufactured by Simmons, Inc. of Providence, Utah.

The rear track drive assembly 110, in one embodiment, includes a tubular subframe 111 that attaches to the motorcycle 102 with a rear swing arm pin 112 and a solid strut 114 that replaces the original shock. The top part of the rear track drive assembly 110 is thus rigidly attached with the frame of the motorcycle and does not move with reference to the frame. A tunnel assembly 116 attaches to both sides of the tubular subframe 111 with tunnel side skirts 118 and provides protective cover for the top of a drive track 120 and mounting for a track roller 122, forward and aft adjustable shocks 124 and 126, and forward and aft track struts 128 and 130. One example of a track suitable for use with the rear track drive assembly 110 is a Camoplast Challenger Track, 121″ long, 12¾″ wide, 1¾″ deep lug, manufactured by Camoplast of Quebec Canada.

The forward and aft shocks 124 and 126, and the forward and aft track struts 128 and 130 together support a hyfax slide suspension 132. A hyfax is a sacrificial plastic glide which runs the length of two parallel rear suspension rails 134 and 136 on both sides. Polystyrene and graphite glide materials can be used because they provide very smooth contact surfaces to the track 120 and low operational friction especially when lubricated with snow.

An adjustable limit strap 138 controls the initial upward tilt of the hyfax slide assembly 132 to the ground and snow underneath. The limiter strap 138 may include adjustment holes in the middle of the strap. Shortening the limiter strap 138 will increase pressure on the front ski 108 and will provide more steering control on steep slopes. Conversely, lengthening the limiter strap 138 will lighten the front ski pressure. Adjusting the limiter strap shifts the center of gravity either forwards or towards the rear, thereby adjusting the center of gravity closer to or farther from the front ski 108. The adjustable limiter strap 138 determines how far away the forward shock 124 can push down the leading edge of the hyfax slide assembly 132. The front leading edge of the hyfax slide suspension 132 is also turned up to provide an approach angle in the range of between about 5 and 30 degrees.

During acceleration and increased loading, the leverage and geometry of the adjustable shock and strut combination is such that the center-point of the track 120, that is supporting the backend weight of snow bike system 100, will dynamically shift further back. The front of the snow bike system 100 will have to take more of the static weight as a result, and the increased static weight will keep the front ski 108 down on the ground and better maintain steering. Such is represented in FIG. 1 by the “dynamic loading point” arrow which can shift forward or back.

A rear track roller 139, in one embodiment, is mounted to the rear end of hyfax slide suspension 132. A jackshaft 140 in a sealed case couples the engine power on a chain and sprocket to a more outboard position where it can power a forward track roller and track drive wheel (covered by tunnel 118 and not shown in FIG. 1) inside the front loop of track 120.

In one embodiment, the length of the rear strut 130 is adjustable. The degree coupling of the back suspension and the amount of lift that will develop on the front ski 108 when climbing a hill can be changed by adjusting the length of rear strut 130. Such adjustment also affects how independent the front and back portions of the hyfax suspension 132 will be from one another, as well as the rear ride height of motorcycle 102.

The geometric relationship of the front and rear adjustable shocks 124 and 126 with their associated front and rear struts 128 and 130 balances the pressures applied to the snow between the front and back halves of the track 120 under the hyfax slide suspension 132. In one embodiment, about 13″ of vertical travel is achieved.

The system 100, as depicted, includes a drive system jackshaft 140. The jackshaft 140, beneficially, positions the drive to the outside of the tunnel rail 118 and allows the above described width of the track 120. In one embodiment, the snow bike system 100 described is a conversion or add-on kit to modify a previously manufactured motorcycle 102 to allow efficient over the snow and ice travel. The front wheel 104, the rear wheel 106, and the swing arm suspension are removed, in one embodiment, to allow for the conversion of the motorcycle into a snow vehicle. A single steering ski assembly 108 is installed in the place of the front wheel to provide for steering. A rear track drive assembly 132 is installed in the place of the rear wheel and swing arm suspension. The rear track drive assembly 132, in one example, includes track slides 134, 136 and a track 120 coupled to the engine 103 via the chain case 140. The track 120 may be driven between a forward track roller and a rear track roller 139 suspended with and positioned fore and aft of the track slides 134, 136.

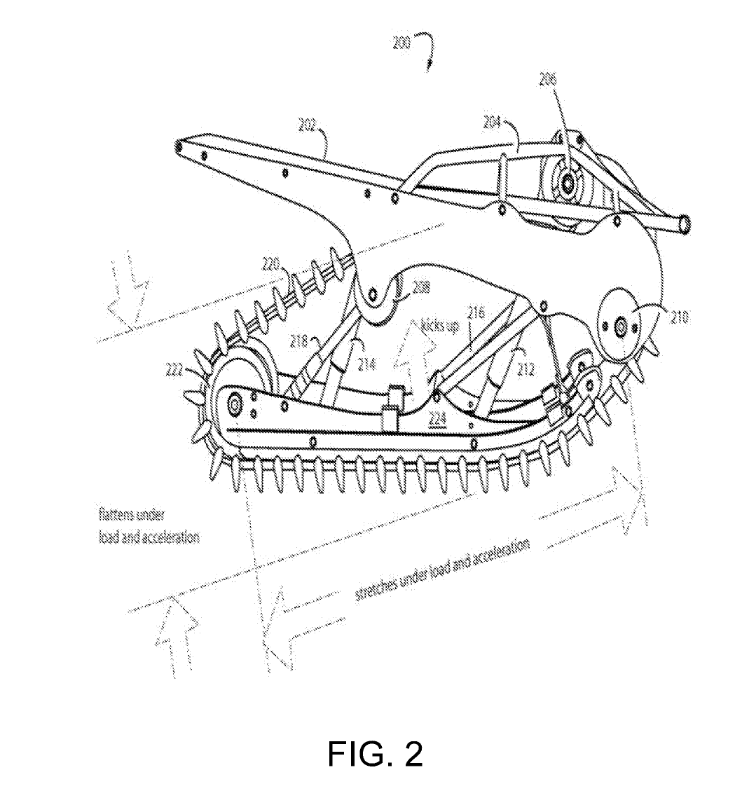

FIG. 2 is a side view diagram illustrating one embodiment of the rear track assembly for converting a motorcycle to a snow vehicle in accordance with embodiments of the invention. As depicted, the rear track assembly 200 includes a track tunnel 202 rigidly attached to the underside of a tubular frame 204. Track tunnel 202 has opposite side skirts that provide for the rigid, not-suspended mounting of a jackshaft 206, top track roller 208, a front track roller and drive sprocket 210, front shock 212, rear shock 214, front strut 216, and rear strut 218. As used herein, the terms “front” and “rear” refer to a position on the snow vehicle with reference to the ski. For example, the front shock 212 refers to the shock that is closer to the ski, and the rear shock 214 refers to the shock that is farther away from the ski.

The jackshaft 206 is in a sealed case and is mounted to the track tunnel 202 such that the transmission of power can be carried from the engine 103 (FIG. 1) to a track 220 through the front track roller and drive sprocket 210. Conventional designs do not drive the front track roller and instead include a long transmission and driveshaft mechanisms to drive one of the aft rollers. The jackshaft 206 may include a disc brake and caliper operated by a right-hand handlebar-mounted hydraulic master cylinder on the motorcycle 102.

The suspension system is configured to collapse flat. The separation distance increases between the front track roller and drive sprocket 210 and a rear belt roller 222 as trail impacts (i.e., changes in terrain) and weight load changes are absorbed. The arcing movement of front strut 216 is especially responsible for this behavior. The suspension system is further configured by the placement of rear strut 218 such that the front of a hyfax slide assembly 224 will be forcefully cantilevered or kicked up relative to the rear belt roller 222 at particular points of the track belt collapse.

The front shock 212 and front strut 216 are strategically disposed in the front half of the suspension system and track drive assembly 200 to control the response of the front portion of the track slide 224 to loads and acceleration. The rear shock 214 and rear strut 218 are disposed in the aft half of the suspension system and track drive assembly 200 to control the response of the rear belt roller 222 and back portion of the track slide 224 to loads and acceleration.

In one embodiment, a back arm slide mechanism included in the rear strut 218 permits the length of the rear strut to slip between a minimum extension position and a maximum extension position. When the rear strut 218 is in the minimum extension position, the front portion of track slide 224 is cantilevered up relative to the rear belt roller 222 and back portion of the track slide 224. This, beneficially, increases the angle of attack or approach of the track. The rear strut is configured, in one embodiment, to transition between the minimum extension position and the maximum extension position by inserting shims 219.

The drive system is such that a first drive chain (not shown) is provided from engine 103 (FIG. 1) to the jack shaft 206 inside tunnel 202. The jack shaft 206 transfers engine driving power to the outside left of tunnel 202. A secondary chain (not shown) drives from jack shaft 206 to front track roller and drive sprocket 210 such that the system drives off the front of the track 220. Chain tensioners are included on both drive chains to accommodate different sprocket gearing options. The secondary chain drive system is sealed inside a chain case. A typical drive system uses O-ring chains, 4140 Chrome-Moly steel axles, CNC machined drive sprockets and bearing cages, and over-sized sealed axle bearings.

In one embodiment, the front suspension assembly (the front shock 212 and front strut 216) are configured to operate independently from the rear suspension assembly (the rear shock 214 and rear strut 218). Stated differently, in one embodiment, there is no mechanical coupling between the front and rear suspension assemblies such that movement in one affects or causes movement in the other.

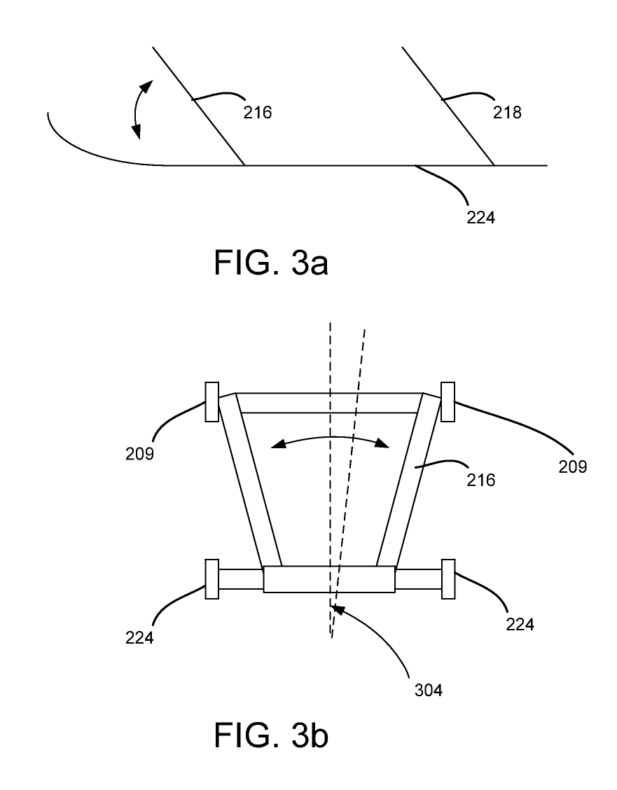

As depicted, both the front strut 216 and the rear strut 218 are disposed between the tunnel (formed by side shrouds 209 and the tubular frame 204) and the slide rails 224. Both the front strut 216 and the rear strut 218 are pivotally connected with the slide rails 224 and the side shrouds 209. As will be discussed in greater detail below with reference to FIGS. 3a-6, in one embodiment, the front strut 216 may be configured to pivot both laterally and longitudinally while the rear strut 218 only pivots longitudinally. The pivoting of the front and rear struts 216, 218 is described in greater detail with reference to FIGS. 3a and 3b.

FIGS. 3a and 3b jointly depict embodiments of directions of pivoting with reference to the front and rear struts 216, 218 in accordance with embodiments of the invention. FIG. 3a is a side view diagram illustrating a simplified embodiment of the front and rear struts. As described above, the front strut 216 and the rear strut 218 are configured to collapse towards the slide rail 224 depending on the terrain. In other words, bumps or other irregularities in the terrain encountered by the rear suspension system cause the slide rail to move towards the tunnel. This movement is dampened by the shocks of the front and rear suspension assemblies. Stated differently, the movement is absorbed by the collapsing of the front and rear struts 216, 218 as depicted by arrow 302. The depicted pivoting is along a longitudinal axis of the snow vehicle. The longitudinal axis is an imaginary axis that extends from the front of the snow vehicle to the rear of the snow vehicle through a center of gravity.

FIG. 3b is a block diagram illustrating one embodiment of the front strut 216 in accordance with embodiments of the invention. As will be discussed in greater detail below, the front strut 216 is configured to pivot longitudinally (see FIG. 3a) and laterally. Lateral pivoting, or side-to-side pivoting, allows for better handling and traction. In one embodiment, the front strut 216 is configured with adjustable lateral pivoting. Stated differently, the front strut 216 is configured to have a range of lateral motion in the range of between about 0 and 10 degrees 304.

In one embodiment, the rear strut 218 is fixed laterally and only allowed to pivot longitudinally, as in FIG. 3a. This beneficially allows for a snow vehicle that, when positioned on a substantially flat surface, is capable of standing without the need of, for example, a kick stand. In other embodiments, the rear strut 218 may be configured to pivot laterally.

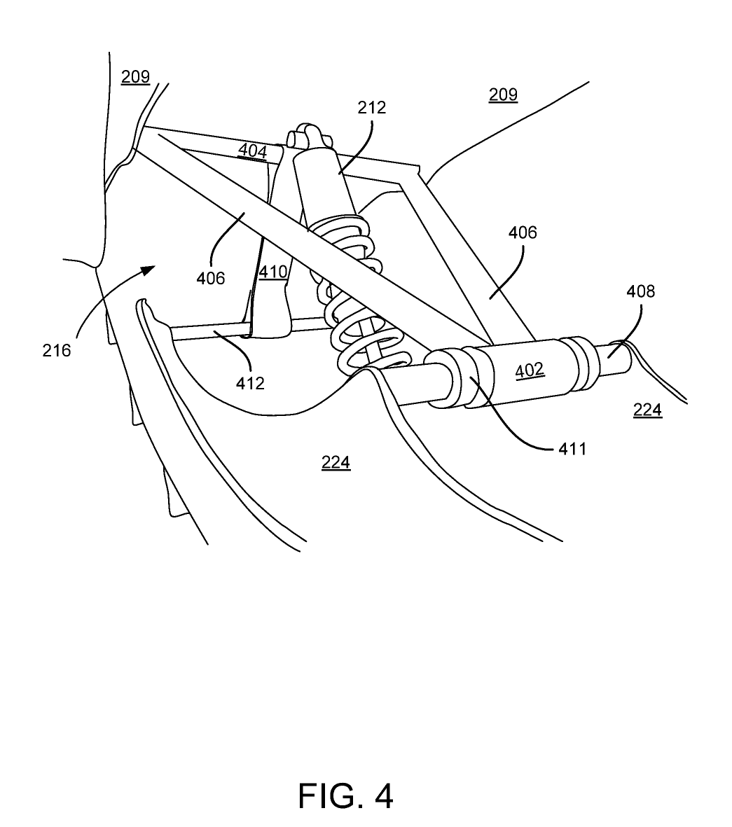

FIG. 4 is a perspective view diagram illustrating one embodiment of the front strut 216 in accordance with embodiments of the invention. The front strut 216, in one embodiment, pivotally couples the side shrouds 209 and the slide rails 224. The side shrouds 209 are fixedly coupled with the motorcycle frame while the slide rails 224 move with reference to the side shrouds 209 in response to changes in the terrain and load applied by the motor and the rider.

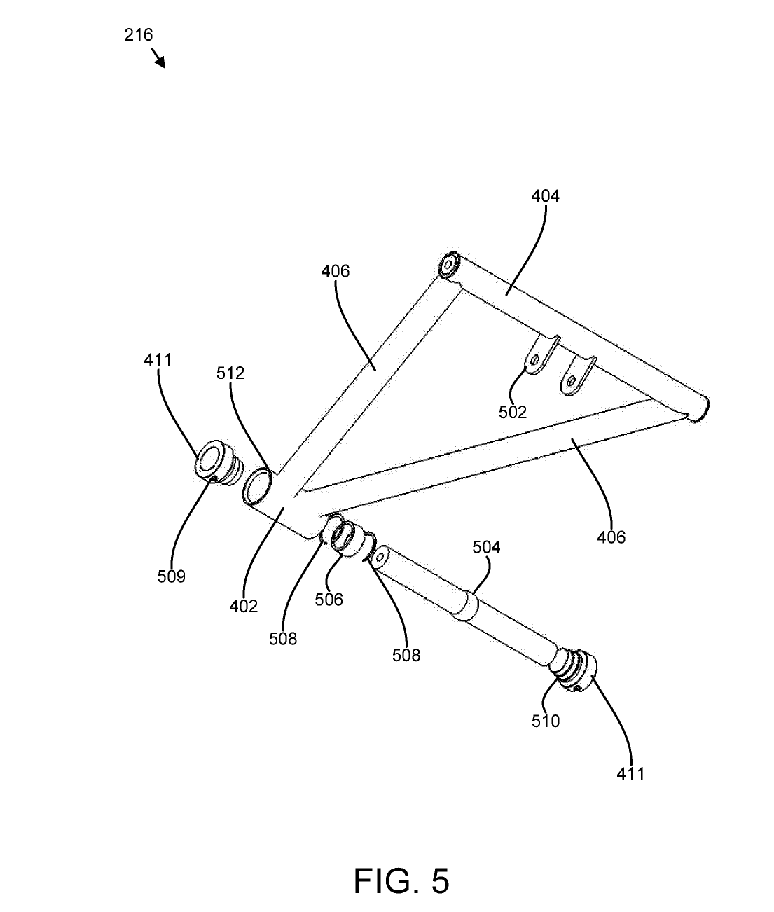

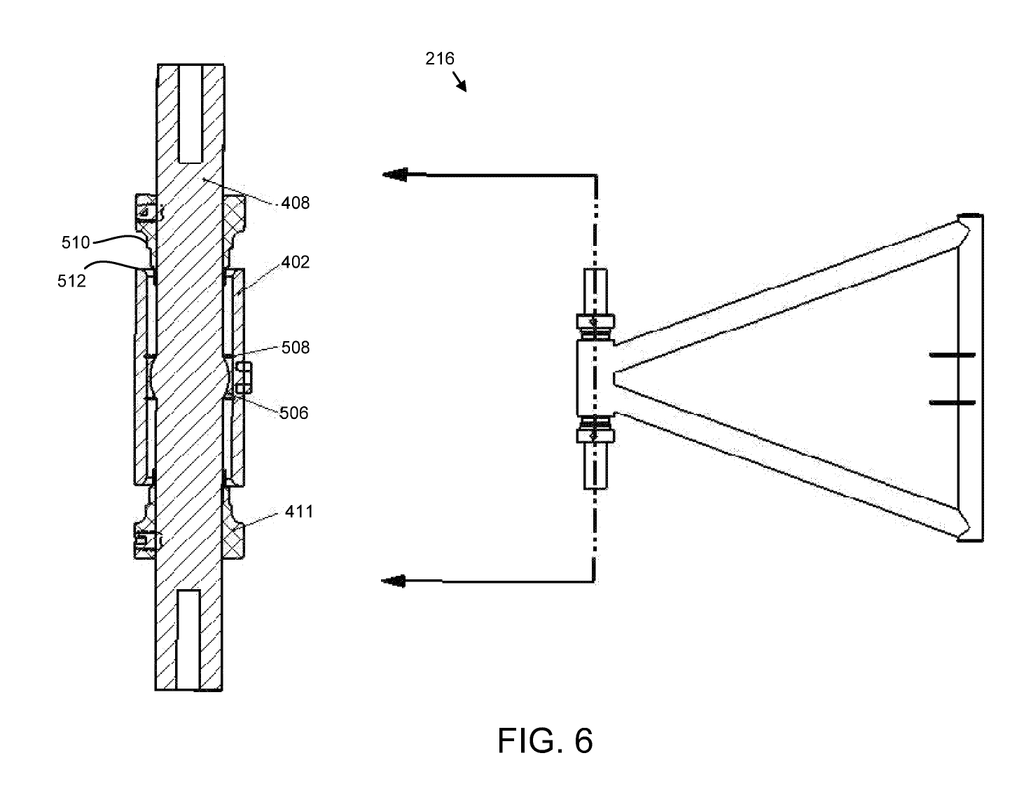

The front strut 216 may be formed of a tubular steel welded to form a generally triangular frame as depicted. Other geometries are contemplated. The front strut 216, in one embodiment, includes a lower tube 402, an upper tube 404, and side tubes 406 coupling the lower and upper tubes 402, 404. The lower tube 402 is configured to engage a cross shaft 408 that is disposed between the slide rails 224. As will be discussed in greater detail below with reference to FIGS. 5 and 6, the lower tube 402 is configured to engage the cross shaft 408 and enable the front strut 216 to pivot laterally. This is achieved via a knuckle formed on the cross shaft 408 upon which the lower tube 402 is seated and allowed to rock from side to side. Positionable adjusters 411 limit the range of side-to-side pivoting of the front strut 216.

The rear strut 218 (see FIGS. 2 and 3a), in one embodiment, does not pivot laterally. Stated differently, the rear strut 218 is laterally fixed so that any lateral movement in the slide rails 224 is translated to the side shrouds 209, and vice versa. That is to say if the rider of the vehicle leans to one side, the lateral leaning movement translates from the frame and the side shrouds 209 through the rear strut 218 and to the rear of the slide rails 224. The front strut 216, however, is able to pivot laterally, and therefore not all of the lateral leaning is translated to the front of the slide rails 224. Only after the lateral leaning has caused the lower tube 402 to contact either the cross shaft 408 or the adjuster 411 does the lateral leaning movement transfer to the front of the slide rails 224. This results in a torsional twisting of the slide rails 224. In other words, as the vehicle leans to one side, the front portion of the slide rails 224 twists with relation to each other and remains in contact with the terrain. This beneficially improves traction because the track is not lifting off the ground when the vehicle leans to one side or the other.

Additionally, this twisting motion gives the rider the sensation that the track behaves more like a traditional rounded motorcycle tire, instead of a track with a hard edge. One benefit of a laterally rigid rear strut is the ability for the vehicle to stand without the use of a kickstand. In other words, if both the front and rear struts pivoted laterally, the vehicle may require a kickstand. Another benefit of the rigid rear strut is the ability to “side hill” on the vehicle. Side hilling is a technique for traversing across an incline which requires the rider to “carve” or otherwise utilize the side of the track to maintain an elevation on the incline (otherwise, the vehicle naturally tends to go downhill). The rigid rear strut allows the rider to “set” the track and cut across the incline or hillside.

Also depicted is the front shock 212. The front shock 212 is coupled, at an upper end, with the upper tube 404 via a spherical rod-end joint and at a lower end with a shock cross shaft (not shown). The rod-end joint allows the front shock 212 to pivot laterally with the front strut 216. A limiter strap 410 may flexibly couple the upper tube 404 with a limiter cross shaft 412.

FIG. 5 is an exploded view diagram illustrating one embodiment of the front strut 216 in accordance with embodiments of the invention. The front strut 216, as described above, may be formed of tubular steel. In other embodiment, the front strut 216 may be formed of other rigid materials including, but not limited to, metal alloys, and composite materials. The front strut 216 may be tubular for weight savings, or substantially solid for increased rigidity.

The front strut 216 includes the upper tube 404, the lower tube 402, and the side tubes 406. The upper tube 404 may also include a shock mount 502 for pivotally coupling with the upper end of the front shock. The lower tube 402 is formed with a diameter selected to receive the cross shaft 408, and a knuckle 504 formed on the cross shaft 408. The knuckle 504, in one embodiment, is integrally formed with the cross shaft 408. In other words, the knuckle 504 and the cross shaft 408 may be machined from a common block of material. In an alternative embodiment, the knuckle 504 may be formed separately and attached to the cross shaft 408. The knuckle 504, as depicted, may have a generally rounded profile to enable the lateral pivoting of the front strut 216. In other words, the knuckle 504 functions as a fulcrum about which the lower tube 402 pivots, and subsequently, the entire front suspension assembly (i.e., front strut 216 and front shock).

The lower tube 402, therefore, is formed with an opening sufficient to receive the cross shaft 408 and the knuckle 504. In one embodiment, the lower tube 402 has an opening in the range of between about 1 and 1.5 inches. The diameter of the knuckle 504, in one embodiment, is in the range of between about 0.5 and 0.875 inches. Accordingly, the difference in diameters of the opening and the knuckle is in the range of between about 0.25 and 0.75 inches. A bushing 506 may be configured to be disposed in the gap between the lower tube 402 and the knuckle 504. The bushing 506, in one embodiment, is a polymer-based ring configured to prevent metal on metal wear of the lower tube and the knuckle. The bushing 506, in one embodiment, may be formed of polytetrafluoroethylene (PTFE), or other suitable polymers. The bushing may be press fit onto the knuckle 504. In one embodiment, the bushing 506 is formed with an interior profile selected to engage the knuckle 504. In other words, the interior surface of the tubular bushing 506 may be formed to match the profile of the knuckle 504. In a further embodiment, the outer surface of the bushing 506 is configured to engage the interior surface of the lower tube 402. Accordingly, in one embodiment, the bushing may have a rounded interior surface to engage the knuckle 504, and a planar exterior surface to engage the lower tube 402.

Snap rings 508 may be positioned adjacent the bushing 506 to maintain the position of the bushing between the knuckle 504 and the lower tube 402. The snap rings 508 may be configured to engage a slot in one of the lower tube 504, or alternatively, the cross shaft 408.

In one embodiment, the positionable adjusters 411 are positioned at each end of the lower tube 402 to limit the lateral pivoting of the front strut 216. The adjusters 411, as depicted, are configured with stepped profile that is insertable into the lower tube 402. Each adjuster 411 may be configured with a lock screw 509 for fixing the position of the adjuster 411 with reference to the cross shaft 408. The diameter of each step 510 decreases as the distance from the lock screw increases. Each step 510 is configured to function as a stop or landing pad for an edge 512 of the lower tube 402. As the front strut 216 laterally pivots, the edge 512 will encounter one of the steps 510 and prevent any further lateral pivoting. By changing the position of the adjusters 411, the rider may influence the range of lateral pivoting of the front strut 216. In other words, if the adjuster 411 is positioned farther away from the lower tube 402, the lower tube is able to pivot through a greater degree of movement. Conversely, changing the position of the adjuster 411 to fully engage the lower tube (i.e., steps 510 fully inserted into the lower tube 402) causes the adjuster 411 to prevent any lateral pivoting of the front strut 216. Accordingly, the adjusters 411 beneficially allow the rider to fine tune the range of lateral motion of the front strut 216.

FIG. 6 is a cross sectional diagram illustrating one embodiment of the front strut 216 in accordance with embodiments of the invention. As described above, the cross shaft 408 and the knuckle 504 are insertable into the lower tube 402 so that the knuckle 504 functions as a pivot point, or fulcrum, for the lower tube 402. Lateral pivoting of the front strut 216 causes the edge 512 of the lower tube 402 to engage a selected step 510 of the adjuster 411. The adjuster 411 may have a stepped profile, as depicted, or alternatively, a gradually decreasing in diameter profile so that finite adjustments are possible.

In one embodiment, the bushing 506 is press fit onto the knuckle before inserting the cross shaft 408 into the lower tube 402. Generally, the steps for assembling the pivoting assembly are as follows: press fit bushing onto knuckle, insert first snap ring into lower tube, insert cross shaft into lower tube, insert second snap ring on opposite side of knuckle from first snap ring, and position the adjusters.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the subject matter of the present disclosure may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Furthermore, the details, including the features, structures, or characteristics, of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A snow vehicle comprising:
a motorcycle frame supporting an engine for driving an endless track, where the frame couples at a rear end to a rear suspension system; and
where the rear suspension system comprises:
a subframe,
a strut disposed between the subframe and the motorcycle frame and rigidly couples the subframe with the motorcycle frame, such that the subframe is substantially fixed in relation to the motorcycle frame,
a tunnel coupled with the subframe and comprising a plurality of upper rollers for supporting an upper portion of the endless track, and
a front strut coupling track slides to the tunnel, where each of the track slides comprises a plurality of lower rollers for supporting a lower portion of the endless track, the front strut comprising:
a lower tube for engaging a cross shaft disposed between the track slides, where the cross shaft is formed with a protruding fulcrum about which the lower tube pivots such that the front strut pivots laterally with respect to the track slides.

2. The snow vehicle of claim 1, where the front strut further comprises an upper tube coupled at each end with the tunnel and side tubes coupling the upper tube with the lower tube.

3. The snow vehicle of claim 2, further comprising a front shock absorber coupled at a first end with the upper tube and coupled at a second end with a cross bar disposed between the track slides.

4. The snow vehicle of claim 2, further comprising a rear strut coupling the track slides to the tunnel, where the rear strut engages a rear cross shaft disposed between the track slides such that the rear strut is substantially laterally fixed in relation to the track slide.

5. The snow vehicle of claim 4, further comprising a rear shock absorber coupled at a first end with the rear strut and coupled at a second end with a cross bar disposed between the track slides.

6. The snow vehicle of claim 5, where the track slides, the front shock, the rear shock, the front strut, the rear strut, the plurality of upper rollers, and the plurality of lower rollers are disposed within the endless track.

7. The snow vehicle of claim 1, where the motorcycle frame couples at a front end to a front suspension system, the front suspension system comprising:
a pair of shock absorbers coupled with the motorcycle frame at upper ends of the pair of shock absorbers; and
a steering ski disposed between the pair of shock absorbers at lower ends of the pair of shock absorbers.

8. The snow vehicle of claim 1, further comprising a bushing disposed between the fulcrum and the lower tube.

9. The snow vehicle of claim 1, further comprising a positionable adjuster disposed on the cross shaft, where the positionable adjuster comprises an exterior surface that engages an end of the lower tube to limit the pivoting of the front strut about the fulcrum.

10. The snow vehicle of claim 9, where the exterior surface varies in diameter to adjust a range of pivoting motion of the front strut.

11. A tracked vehicle suspension comprising:
a tunnel comprising a plurality of upper rollers for supporting an upper portion of the endless track, and
a front strut coupling track slides to the tunnel, where each of the track slides comprises a plurality of lower rollers for supporting a lower portion of the endless track, the front strut comprising:
a lower tube for engaging a cross shaft disposed between the track slides, where the cross shaft is formed with a protruding fulcrum about which the lower tube pivots such that the front strut pivots laterally with respect to the track slides.

12. The tracked vehicle suspension of claim 11, where the front strut further comprises an upper tube coupled at each end with the tunnel and side tubes coupling the upper tube with the lower tube.

13. The tracked vehicle suspension of claim 12, further comprising a front shock absorber coupled at a first end with the upper tube and coupled at a second end with a cross bar disposed between the track slides.

14. The tracked vehicle suspension of claim 12, further comprising a rear strut coupling the track slides to the tunnel, where the rear strut engages a rear cross shaft disposed between the track slides such that the rear strut is substantially laterally fixed in relation to the track slide.

15. The tracked vehicle suspension of claim 14, further comprising a rear shock absorber coupled at a first end with the rear strut and coupled at a second end with a cross bar disposed between the track slides.

16. The tracked vehicle suspension of claim 15, where the track slides, the front shock, the rear shock, the front strut, the rear strut, the plurality of upper rollers, and the plurality of lower rollers are disposed within the endless track.

17. The tracked vehicle suspension of claim 11, further comprising a bushing disposed between the fulcrum and the lower tube.

18. The tracked vehicle suspension of claim 11, further comprising a positionable adjuster disposed on the cross shaft, where the positionable adjuster comprises an exterior surface that engages an end of the lower tube to limit the pivoting of the front strut about the fulcrum.

19. The tracked vehicle suspension of claim 18, where the exterior surface varies in diameter to adjust a range of pivoting motion of the front strut.

20. A tracked vehicle suspension comprising:
a tunnel comprising a plurality of upper rollers for supporting an upper portion of the endless track,
a front strut coupling track slides to the tunnel, where each of the track slides comprises a plurality of lower rollers for supporting a lower portion of the endless track, the front strut comprising:
a lower tube for engaging a cross shaft disposed between the track slides, where the cross shaft is formed with a protruding fulcrum about which the lower tube pivots such that the front strut pivots laterally with respect to the track slides; and
a rear strut coupling the track slides to the tunnel, where the rear strut engages a rear cross shaft disposed between the track slides such that the rear strut is substantially laterally fixed in relation to the track slide.
